(19) United States
(12) Patent Application Publication
(10) Pub. No.: US 2013/0236876 A1
(43) Pub. Date: Sep. 12, 2013

(54) Generating Visually Enhanced Question Topic Repetition Learning Content

(71) Applicant: Derek Moore, South Dartmouth, MA (US)

(72) Inventor: Derek Moore, South Dartmouth, MA (US)

(21) Appl. No.: 13/796,569

(22) Filed: Mar. 12, 2013

Related U.S. Application Data
(60) Provisional application No. 61/609,690, filed on Mar. 12, 2012.

(51) Int. Cl. G09B 7/00

(52) U.S. Cl. CPC G09B 7/00
USPC 434/322

(57) ABSTRACT

A method performed by one or more processing devices, comprises: displaying, through a graphical user interface, test information in a layered structure; wherein a first layer in the layered structure is configured to display the test information following selection of a control in the graphical user interface; wherein a second layer in the layered structure is configured to display the test information following a display of the test information in the first layer; receiving, through the graphical user interface, one or more answers to one or more questions received in the test information; and generating, in response to receiving, information indicative of a test score.

### CLAIM OF PRIORITY

This application claims priority under 35 U.S.C. §119(e) to provisional U.S. Patent Application 61/609,690, filed on Mar. 12, 2012, the entire contents of which are hereby incorporated by reference.

### BACKGROUND

An Internet forum, or message board, is an online discussion site where people can hold conversations in the form of posted messages.

### BRIEF DESCRIPTION OF THE FIGURES

FIGS. 1-9 are screen images of user interfaces generated by the system for an engagement brokerage service.

FIG. 10 is a diagram of components of the system.

### DETAILED DESCRIPTION

A system described herein is configured to improve the efficiency of orthopedic education and encourage professional collaboration by creating an online learning resource and social networking website focused on orthopedic education and standardized test and board preparation.

The system is configured to provide an educational platform that enables young surgeons to create orthopedic review content while simultaneously using the platform as a learning tool and forum for peer-to-peer interaction. The system is implemented around the following core beliefs:

Orthopedic education can be improved and made more efficient.

With proper incentives and guidance, young orthopedic surgeons can and will produce high-quality orthopedic review content to the benefit of themselves and their peers. Physicians should be rewarded for their publishing contribution.

The system provides free, reliable, peer-reviewed educational resources for exam preparation and solidify their presence and use of the site by incorporating a multitude of social networking and industry touch-points for these surgeons-in-training to continue using the site even as mature, independently-practicing clinicians. In summary, the system attracts young physicians to the site with “addictive” test preparation, then keep them on the site as they mature with a series of social networking and practice management solutions. In an example, the system is configured to implement the following techniques:

VEQTR Learning Technique

The VEQTR (Visually-Enhanced-Question-Topic-Repetition) learning technique consolidates proven memorization methods within an internet framework to create more efficient learning and test taking skills. Successful standardized test-taking requires a unique skill set that many orthopedic residencies do not emphasize.

The VEQTR learning technique simulates like a flashcard system, where the same material is repetitively viewed and reinforced over time. This rapid repetition of material, strengthened by visual cues and integrated into practice questions, optimizes memorization and test taking skills.

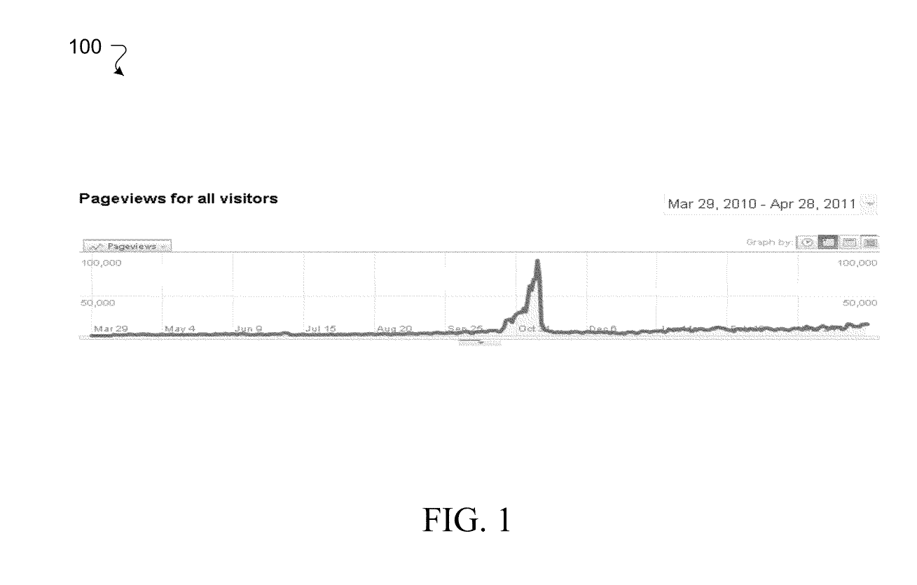

The significant jump in pageviews surrounding the OITE testing period (Figure below) is proof of concept that residents find the VEQTR learning technique an effective way to prepare for these examinations, as shown in graphical user interface 100 in FIG. 1.

The system has achieved content maturity, signifying that the site contains a comprehensive overview of each of the major, tested topics in orthopedic surgery knowledge. This content continues to be updated and edited on a day-to-day basis by several well-reputed, surgeon-contributors.

Question Bank

The system has already compiled a question bank of over 1,900 peer-reviewed questions that are being actively used in test preparation by thousands of site visitors per day. This content continues to be reviewed, revised, and added upon on a day-to-day basis.

In an example, the VEQTR techniques include a modular learning technique. Generally, a modular learning technique includes a method of presenting information to a user numerous times, e.g., in discrete segments.

As shown in the below figure, the user of the system accesses, via the system, a web page pertaining to a particular topic. In this example, the web page includes an outline of topics that are commonly tested for the topic. Additionally, the page includes information indicative of a number of times this topic has been tested, e.g., on board exams.

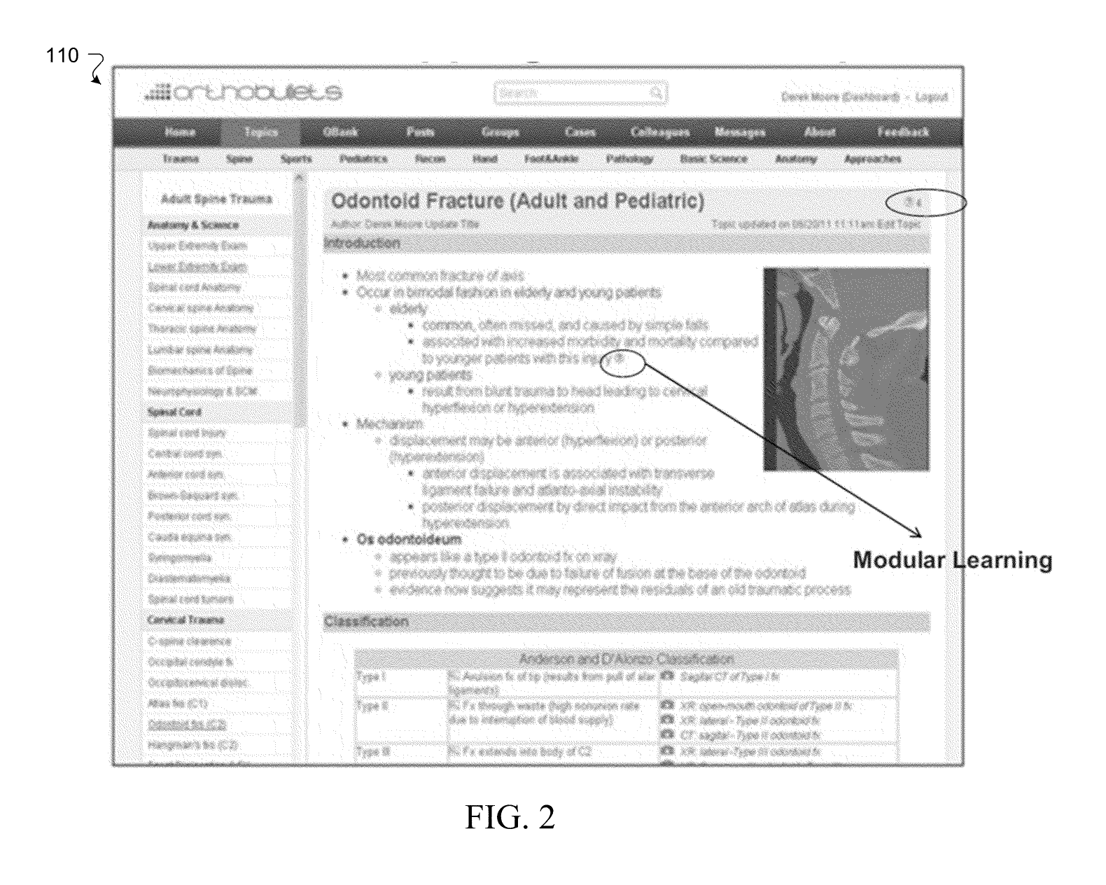

When a portion of the outline includes specific information that was previously tested (e.g., included in a test), the portion is associated with a visual representation (e.g., an image of a question mark) indicating that this information was previously tested. Upon selection of the visual representation, the system displays for the user a question relating to the information that was previously tested, as shown in graphical user interface 110 in FIG. 2.

Additionally, the bottom of the web page pertaining to the topic lists all of the questions that were previously tested for the topic. In an example, a user should have already viewed these questions, e.g., following selection of the visual representations. Through re-display of the questions, the system promotes repetition in learning.

OSPREY

The system is also configured to implement OSPREY: A Communal Learning Platform. The system is built around the belief that orthopedic surgeons have all the ingredients needed to create effective orthopedic review material independent of publishing companies. Therefore, we have created an educational resource that incrementally improves with the communal contribution of the orthopedic surgeons who use it as a learning resource. It's a simple but powerful concept:

The system is a “regulated-open-source-system” meaning only select individuals can create and modify content. We have assembled a team of orthopedic surgeons who have all demonstrated a history of excellent test performance and a dedication to academics. The team using the system includes PGY5 orthopedic residents, specialty fellows, young orthopedic surgeons, and supervising thought leaders from academic centers. All are trained in the United States.

The system includes strict definitions on the scope and source of our content included on the system. Topics include content from trusted review resources and tested concepts from prior test questions.

The content in the system goes through a strict and transparent content approval process before it reaches final approval. The process consists of an innovative restricted-open-source educational platform called the OSPREY (Open-Source-Peer-Review-Education) System. Through the OSPREY system content continues to improves and evolves over time while it is being used as an education tool based on the feedback of the people using it. Content does not reach final approval until it is approved by six orthopedic surgeons on three levels of seniority (see illustration below). This approval process is transparent to the visitor so they can gauge the quality of the content. All users and visitors are able to place error alert on content to notify the authors and visitors that content may be erroneous and must be improved.

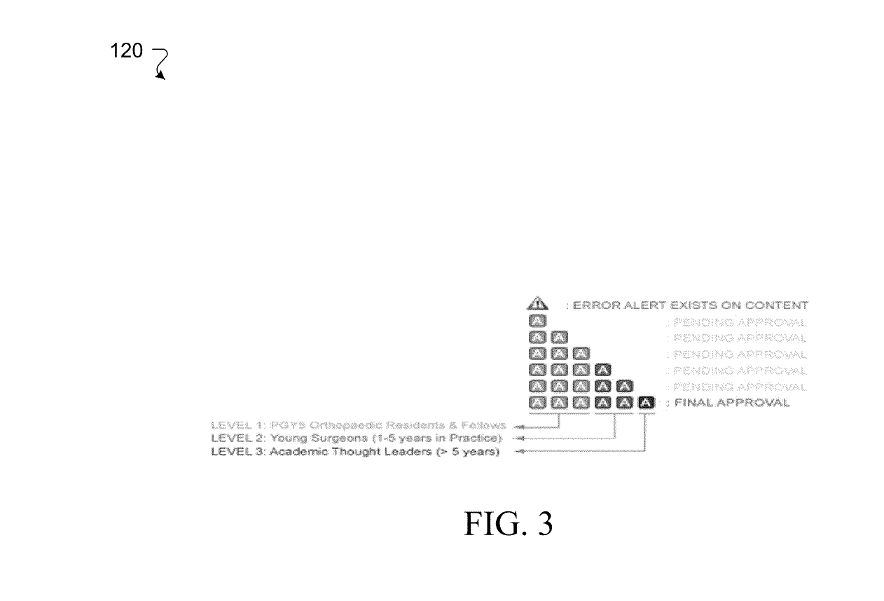

Finally, content is rated on a Five-Star rating system by Visitors. This rating systems provides the system with valuable feedback and allows the system to continue to improve content based on the visitors experience, as shown in graphical user interface 120 in FIG. 3.

Lifelong Learning while Simultaneously Raising the Bar on Orthopedic Education

The beauty of this system is that all physicians benefit from their involvement. The residents and fellows “learn and earn” while writing content and the surgeons and thought-leader “learn and earn (CME planned)” while approving content. Simultaneously, we are creating a valuable free educational resource for the orthopedic community.

By inviting surgeons to contribute to the content and question-building process, the system promotes the “for us, by us” mentality that attracts contributors and viewers to the site. In contrary to the publishing companies who are the sole financial beneficiaries of resident academic work, OrthoBullets.com offers physicians and residents-in-training the opportunity to supplement their incomes by contributing content and questions to the site while simultaneously learning the materials on which they will be tested in the future—“Earn While You Learn.”

In an example, OSPREY includes an internal and an external review of questions that are submitted to the system. The internal review process includes administrators and other designated reviewers that have been designated to review and to approve questions. The external review process includes users of the system that review questions and rate the questions (e.g. using a star system).

As shown in the below figure, “error approval” includes an internal process, in which designated users (experts and professionals in a certain field) approve a submitted question. In an example, the system includes five different level of approval. For example, one level of approval includes approval from at least three experts in a field. Another level of approval may include approval from at least one academic in the field.

As a question is approved at each level, an “A” is added to the “error approval” column to indicate that the question has passed an additional layer of approval. The avg column includes information indicative of reviews received by users of the system for a particular submission.

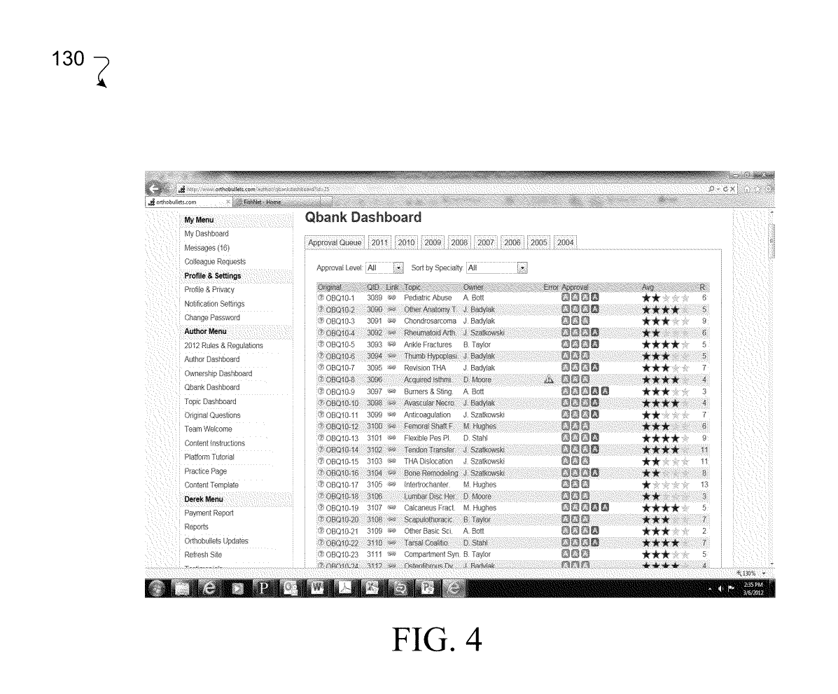

In an example, a question is released to a test bank based on the external review process and based on the internal review process. In this example, the question may be released to the test bank when the question has cleared three internal levels of approval and when the question has received an average of at least three stars for a rating, as shown in graphical user interface 130 in FIG. 4.

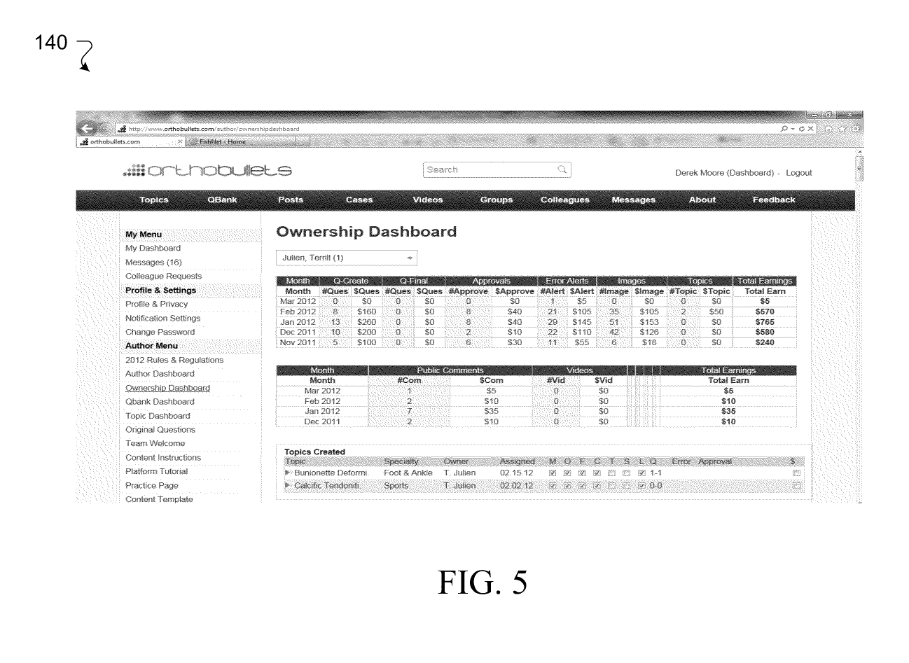

As illustrated in graphical user interface 140 in FIG. 5, payment for questions may be implemented as an a la carte system, in which users are paid a particular amount of money for submission of a question, for approval of a question, and so forth.

As shown in the FIG. 5, payment to users (e.g., based on submissions) may be implemented as a game. In the game, users are able to track the number of points (e.g., the number of dollars) that they have received for various submissions. In another example, instead of accruing points, users accrue bullets. Following receipt of a certain number of bullets, a user may exchange the bullets for gifts or for cash. A goal of the game includes optimizing an accumulation of dollars.

Lineage TestMaster

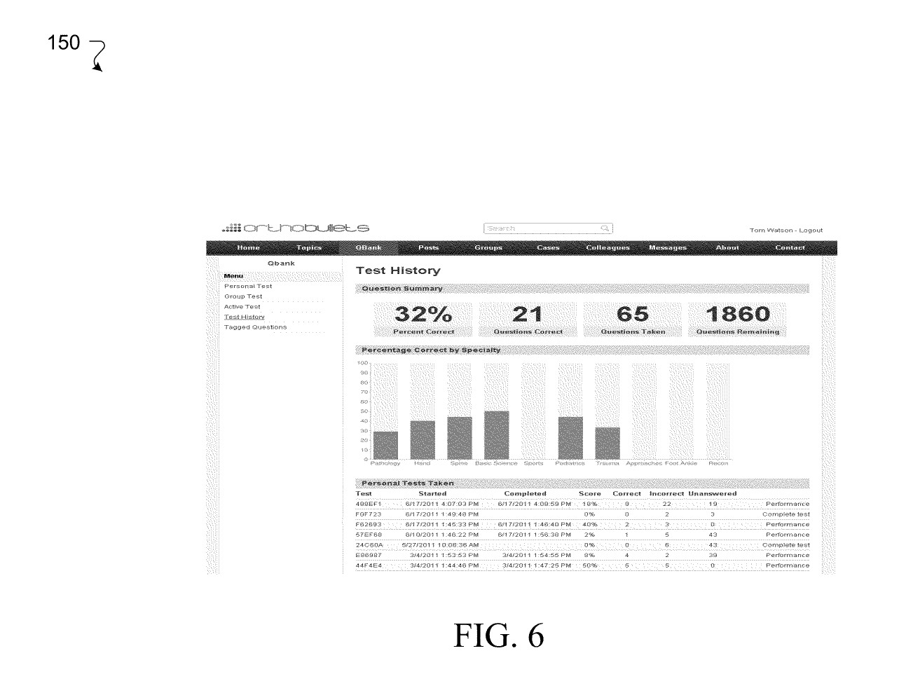

In addition to providing peer-reviewed and reliable orthopedic knowledge content, the system also offers testing functionality that allows individual users to create customized tests designed to assist in enhancing both broad knowledge base and specific topics within orthopedic education and clinical practice. Additionally, the system includes a “group-testing” system, where a “proctor” or residency director can issue examinations to test groups of residents, while monitoring their progress in real time. This function should aid significantly in identifying educational gaps and weaknesses both in resident learning and the program's didactic design and curriculum, as shown in graphical user interface 150 in FIG. 6.

Orthobullets Professional Social Network

The system includes a suite of social networking functions that allows physicians to collaborate with their peers. Although there are other sites that offer similar functions, ours is unique in that it is built of a foundation of education. Therefore, while other physician networks contain multiple posts and contents focusing on “non-educational” aspects of medicine, our social network is designed to be focus on education, thus providing great value to the users.

Successfully building a social network can be a challenge. The critical variable is to have “valuable” content that brings the user to the site and keeps them there. Our strategy is to use our highly valued questions and review content to bring young surgeons/residents to the educational site, and keep them there with a series of social networking functioning that will help these young surgeons communicate with others as the develop and mature as physicians.

iConnect

In an example, the system also implements a technique to connects physicians using the system with patients and with service providers (e.g., pharmaceutical representatives). In this example, the connections include one-way connections, in which a physician may contact (e.g., via email) a patient and/or a pharmaceutical rep, but the patient and/or pharmaceutical rep cannot contact the physician.

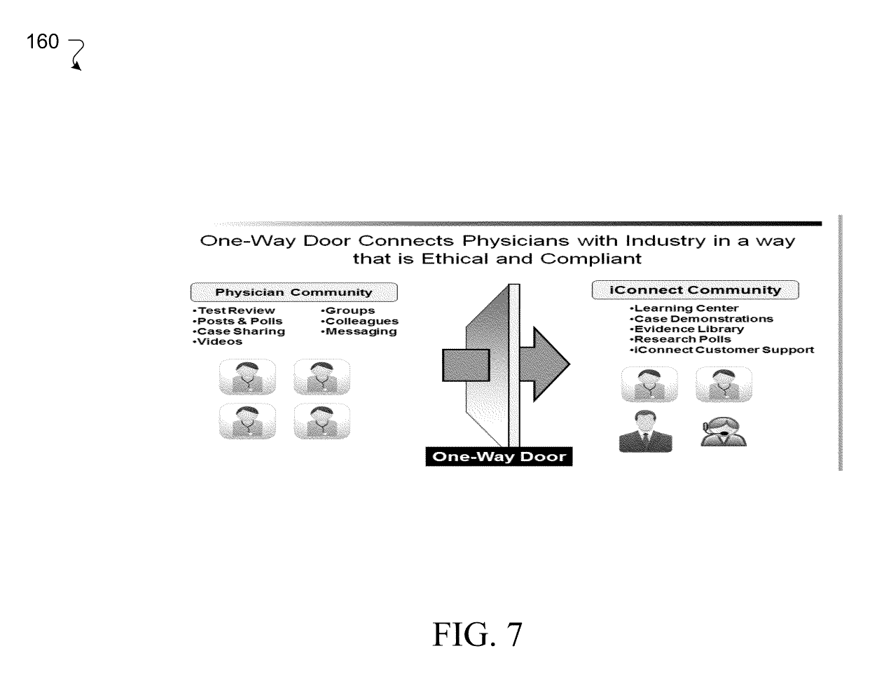

As shown in the below example, the iConnect technique works as a one-way door, promoting communication from the physician community of the system to the iConnect community of the system. Generally, the iConnect community includes users of the system (e.g., pharmaceutical representatives) that input contact information into the system, e.g., to promote contact with physicians, as shown in graphical user interface 160 in FIG. 7.

Although not shown in the above figure, the system may implement another one-way door between the physician community and the patient community.

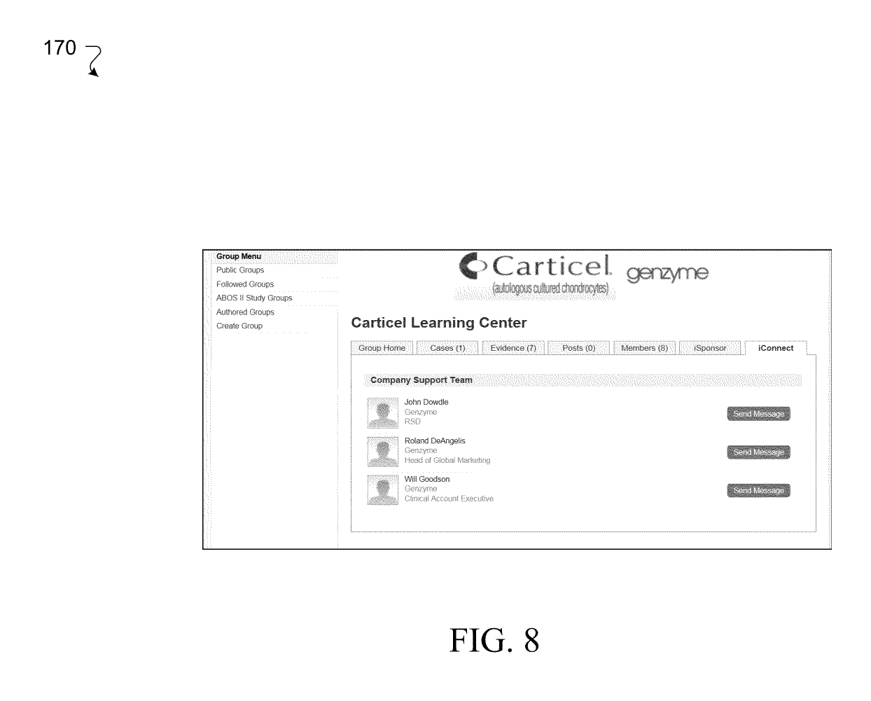

As shown in graphical user interface 170 in FIG. 8, the iConnect technique may provide a dedicated space on the system for interaction with iConnect members that are affiliated with a particular area (e.g., a particular pharmaceutical).

In still another example, the system promotes interactions among users of the system, e.g., through message boards, online posts, a social networking service and so forth. In this example, the interactions pertain to evidence based medicine. In an example, the system is configured to prompt the user for a PMID that is related to the information included a post of the user. Generally, a PMID includes a value indicative of a PubMed-Indexed for MEDLINE. In this example, the system includes a rules engine that scans contents of a post to determine if the post includes a PMID. When the rules engine determines that the post does not include a PMID, the system prompts the user to enter the PMID, and in some examples, prevents the post from publishing until a PMID has been entered.

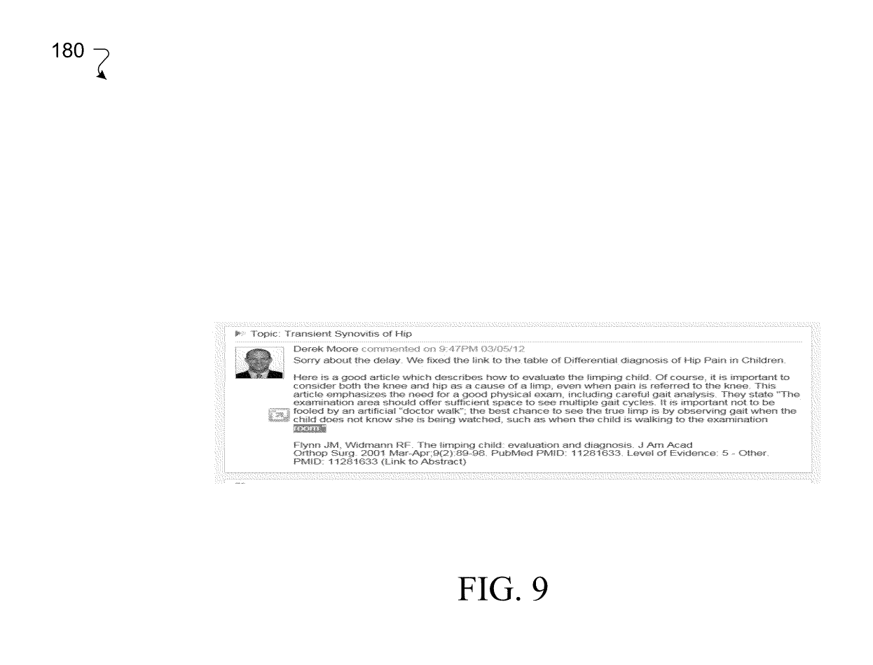

As shown in graphical user interface 180 in FIG. 9, the system displays posts in association with relevant PMIDs.

Humanitarian Case

In an example, the system may be configured to implement an auction in which physicians may post materials that are needed (e.g., screws that are needed for surgeries). In this example, a physician may be in a developing country performing humanitarian work. As part of the humanitarian work, the physician may need certain materials to perform a surgery. However, the physician may not have access to the materials. Further, obtaining the materials through traditional channels may be expensive, e.g., as sales representatives and other middle men are employed to facilitate sales of the materials.

In this example, the system may be configured to implement an auction web site, in which the physician can post the needed materials. Then, medical device companies can submit bids, e.g., to be the entity that provides the materials. In this example, the physician may select to purchase the materials from the medical device company with the lowest bid. Additionally, through the website, donors may make donations for purchase of the products.

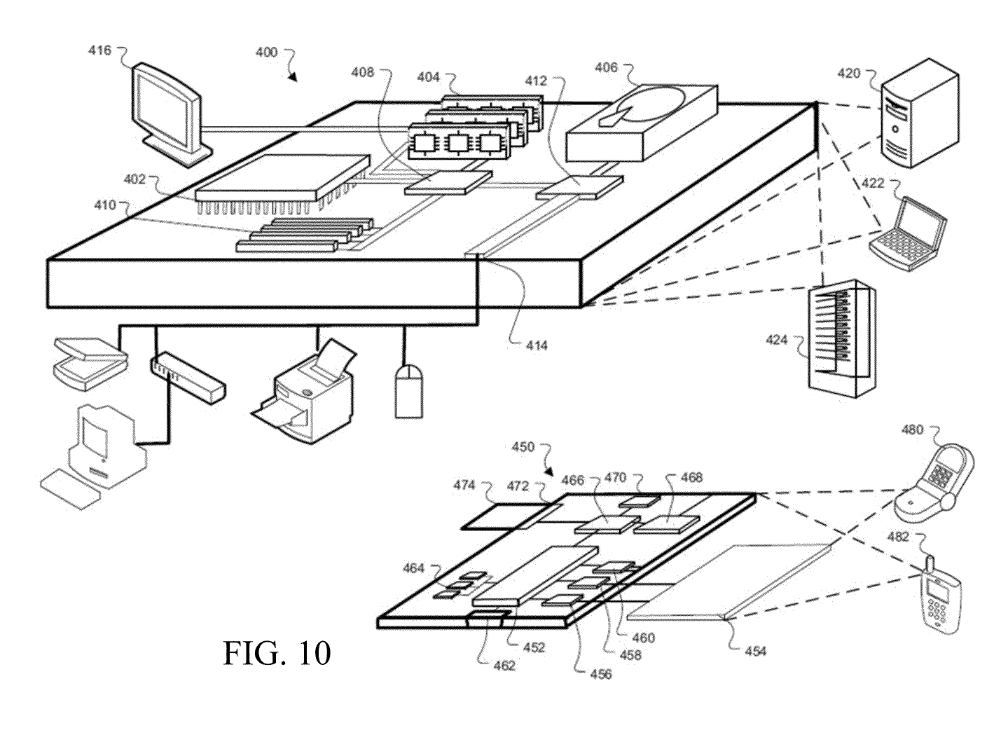

FIG. 10 shows an example of computer device 400 and mobile computer device 450, which can be used with the techniques described here. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 400 includes processor 402, memory 404, storage device 406, high-speed interface 408 connecting to memory 404 and high-speed expansion ports 410, and low speed interface 412 connecting to low speed bus 414 and storage device 406. Each of components 402, 404, 406, 408, 410, and 412, are interconnected using various busses, and can be mounted on a common motherboard or in other manners as appropriate. Processor 402 can process instructions for execution within computing device 400, including instructions stored in memory 404 or on storage device 406 to display graphical data for a GUI on an external input/output device, such as display 416 coupled to high speed interface 408. In other implementations, multiple processors and/or multiple buses can be used, as appropriate, along with multiple memories and types of memory. Also, multiple computing devices 400 can be connected, with each device providing portions of the necessary operations (e.g., as a server bank, a group of blade servers, or a multi-processor system).

Memory 404 stores data within computing device 400. In one implementation, memory 404 is a volatile memory unit or units. In another implementation, memory 404 is a non-volatile memory unit or units. Memory 404 also can be another form of computer-readable medium, such as a magnetic or optical disk.

Storage device 406 is capable of providing mass storage for computing device 400. In one implementation, storage device 406 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, such as those described above. The data carrier is a computer- or machine-readable medium, such as memory 404, storage device 406, memory on processor 402, and the like.

High-speed controller 408 manages bandwidth-intensive operations for computing device 400, while low speed controller 412 manages lower bandwidth-intensive operations. Such allocation of functions is an example only. In one implementation, high-speed controller 408 is coupled to memory 404, display 416 (e.g., through a graphics processor or accelerator), and to high-speed expansion ports 410, which can accept various expansion cards (not shown). In the implementation, low-speed controller 412 is coupled to storage device 406 and low-speed expansion port 414. The low-speed expansion port, which can include various communication ports (e.g., USB, Bluetooth®, Ethernet, wireless Ethernet), can be coupled to one or more input/output devices, such as a keyboard, a pointing device, a scanner, or a networking device such as a switch or router, e.g., through a network adapter.

Computing device 400 can be implemented in a number of different forms, as shown in the figure. For example, it can be implemented as standard server 420, or multiple times in a group of such servers. It also can be implemented as part of rack server system 424. In addition or as an alternative, it can be implemented in a personal computer such as laptop computer 422. In some examples, components from computing device 400 can be combined with other components in a mobile device (not shown), such as device 450. Each of such devices can contain one or more of computing device 400, 450, and an entire system can be made up of multiple computing devices 400, 450 communicating with each other.

Computing device 450 includes processor 452, memory 464, an input/output device such as display 454, communication interface 466, and transceiver 468, among other components. Device 450 also can be provided with a storage device, such as a microdrive or other device, to provide additional storage. Each of components 450, 452, 464, 454, 466, and 468, are interconnected using various buses, and several of the components can be mounted on a common motherboard or in other manners as appropriate.

Processor 452 can execute instructions within computing device 450, including instructions stored in memory 464. The processor can be implemented as a chipset of chips that include separate and multiple analog and digital processors. The processor can provide, for example, for coordination of the other components of device 450, such as control of user interfaces, applications run by device 450, and wireless communication by device 450.

Processor 452 can communicate with a user through control interface 458 and display interface 456 coupled to display 454. Display 454 can be, for example, a TFT LCD (Thin-Film-Transistor Liquid Crystal Display) or an OLED (Organic Light Emitting Diode) display, or other appropriate display technology. Display interface 456 can comprise appropriate circuitry for driving display 454 to present graphical and other data to a user. Control interface 458 can receive commands from a user and convert them for submission to processor 452. In addition, external interface 462 can communicate with processor 442, so as to enable near area communication of device 450 with other devices. External interface 462 can provide, for example, for wired communication in some implementations, or for wireless communication in other implementations, and multiple interfaces also can be used.

Memory 464 stores data within computing device 450. Memory 464 can be implemented as one or more of a computer-readable medium or media, a volatile memory unit or units, or a non-volatile memory unit or units. Expansion memory 474 also can be provided and connected to device 450 through expansion interface 472, which can include, for example, a SIMM (Single In Line Memory Module) card interface. Such expansion memory 474 can provide extra storage space for device 450, or also can store applications or other data for device 450. Specifically, expansion memory 474 can include instructions to carry out or supplement the processes described above, and can include secure data also. Thus, for example, expansion memory 474 can be provide as a security module for device 450, and can be programmed with instructions that permit secure use of device 450. In addition, secure applications can be provided via the SIMM cards, along with additional data, such as placing identifying data on the SIMM card in a non-hackable manner.

The memory can include, for example, flash memory and/or NVRAM memory, as discussed below. In one implementation, a computer program product is tangibly embodied in an data carrier. The computer program product contains instructions that, when executed, perform one or more methods, such as those described above. The data carrier is a computer- or machine-readable medium, such as memory 464, expansion memory 474, and/or memory on processor 452, that can be received, for example, over transceiver 468 or external interface 462.

Device 450 can communicate wirelessly through communication interface 466, which can include digital signal processing circuitry where necessary. Communication interface 466 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 468. In addition, short-range communication can occur, such as using a Bluetooth®, WiFi, or other such transceiver (not shown). In addition, GPS (Global Positioning System) receiver module 470 can provide additional navigation- and location-related wireless data to device 450, which can be used as appropriate by applications running on device 450.

Device 450 also can communicate audibly using audio codec 460, which can receive spoken data from a user and convert it to usable digital data. Audio codec 460 can likewise generate audible sound for a user, such as through a speaker, e.g., in a handset of device 450. Such sound can include sound from voice telephone calls, can include recorded sound (e.g., voice messages, music files, and the like) and also can include sound generated by applications operating on device 450.

Computing device 450 can be implemented in a number of different forms, as shown in the figure. For example, it can be implemented as cellular telephone 480. It also can be implemented as part of smartphone 482, personal digital assistant, or other similar mobile device.

Using the techniques described herein, a system is configured to generate a filtered view of a content stream. In an example, the system generates the filtered view based on search criteria. In this example, the system identifies content items that satisfy the search criteria. The system populates the filtered view with the identified content items.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

For situations in which the systems and techniques discussed herein collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (e.g., to a city, zip code, or state level), so that a particular location of the user cannot be determined.

All processes described herein and variations thereof (referred to as “the processes”) contain functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A method performed by one or more processing devices, comprising:
displaying, through a graphical user interface, test information in a layered structure;
wherein a first layer in the layered structure is configured to display the test information following selection of a control in the graphical user interface;
wherein a second layer in the layered structure is configured to display the test information following a display of the test information in the first layer;
receiving, through the graphical user interface, one or more answers to one or more questions received in the test information; and
generating, in response to receiving, information indicative of a test score.

2. One or more machine-readable media configured to store instructions that are executable by one or more processing devices to perform operations comprising:
displaying, through a graphical user interface, test information in a layered structure;
wherein a first layer in the layered structure is configured to display the test information following selection of a control in the graphical user interface;
wherein a second layer in the layered structure is configured to display the test information following a display of the test information in the first layer;
receiving, through the graphical user interface, one or more answers to one or more questions received in the test information; and
generating, in response to receiving, information indicative of a test score.

3. An electronic system comprising:
one or more processing devices; and
one or more machine-readable media configured to store instructions that are executable by the one or more processing devices to perform operations comprising:
displaying, through a graphical user interface, test information in a layered structure;
wherein a first layer in the layered structure is configured to display the test information following selection of a control in the graphical user interface;
wherein a second layer in the layered structure is configured to display the test information following a display of the test information in the first layer;
receiving, through the graphical user interface, one or more answers to one or more questions received in the test information; and
generating, in response to receiving, information indicative of a test score.

4. The method of claim 1, further comprising:
receiving information indicative of a test question;
implementing an electronic, interview review process of the test question;
implementing an electronic, external review process of the test question; and
determining, based on implementation of the external and the internal review processes, whether the test question is publically released.

5. The method of claim 1, further comprising:
generating an online community of service providers;
receiving, from a physician, a request for an electronic communication with at least one of the service providers; and
establishing, using contact information of the at least one of the service providers, an electronic communication with the physician and the at least one of the service providers;
wherein the community of service providers are blocked from viewing contact information of the physician.
